(19) United States
(12) Patent Application Publication
(10) Pub. No.: US 2014/0339168 A1
(43) Pub. Date: Nov. 20, 2014

(54) CERAMIC MEMBRANE CONTAINING CARBON NANOTUBES

(71) Applicants: Liang Hong, Singapore (SG); Xinwei Chen, Singapore (SG)

(72) Inventors: Liang Hong, Singapore (SG); Xinwei Chen, Singapore (SG)

(73) Assignee: National University of Singapore, Singapore (SG)

(21) Appl. No.: 14/344,165

(22) PCT Filed: Sep. 12, 2012
(86) PCT No.: PCT/SG2012/000331

§ 371 Date: Mar. 11, 2014

Related U.S. Application Data
(60) Provisional application No. 61/533,317, filed on Sep. 12, 2011.

(51) Int. Cl. C02F 1/44; B01D 67/00; B01D 71/02; B01D 69/12; B01D 71/04

(52) U.S. Cl. CPC C02F 1/444; B01D 69/12; B01D 71/04; B01D 71/021; B01D 67/0072; B82Y 99/00
USPC 210/651; 210/500.26; 427/244; 977/742

(57) ABSTRACT

A ceramic membrane for separating oil from water. The membrane contains a ceramic substrate having pore channels, and carbon nanotubes extending from surfaces of the ceramic substrate, wherein the ceramic substrate has a thickness of 0.1 to 50 mm and a porosity of 5 to 95%, the pore channels have a diameter of 0.001 to 20 μm, and the carbon nanotubes constitute 0.01 to 40% by weight. Also disclosed are a method of preparing this membrane and a method of using it.

### BACKGROUND

Oil pollution is a major environmental concern.

Oil particles smaller than 150 μm are difficult to remove. Current purification methods for these small oil particles, e.g., biological treatment and activated carbon adsorption, are both costly and inefficient.

Ceramic membrane filtration by size exclusion is a promising alternative. Indeed, porous ceramic membranes have several advantages, including stability, durability, antifouling properties, and good mechanical properties. See Guizard et al., Desalination, 147, 275-80 (2002) and Lobo et al., Journal of Membrane Science, 278, 328-34 (2006). However, the deformable nature of oil drops renders filtration by size exclusion ineffective.

There is a need to develop effective ceramic membranes for separating oil from water.

### SUMMARY

Disclosed herein is a porous ceramic membrane that can effectively separate oil from water.

One aspect of this invention relates to a ceramic membrane containing a ceramic substrate and carbon nanotubes.

The ceramic substrate has a thickness of 0.1 to 50 mm (e.g., 0.2-20 mm and 0.5-5 mm), a porosity of 5 to 95% (e.g., 10-70% and 20-50%), and a plurality of pore channels having a diameter of 0.001 to 20 μm (e.g., 0.005-10 μm and 0.01-2 μm). It can be made of zirconia, alumina, silicon carbide, silicon nitride, titanium carbide, zinc oxide, boron nitride, mullite, or a combination thereof.

The carbon nanotubes, extending from surfaces of the ceramic substrate, constitute 0.01 to 40% (e.g., 0.1-20% and 0.5-5%) by weight of the ceramic membrane.

In one embodiment, the ceramic membrane is a cylinder having an outside diameter of 0.05 to 1000 mm (e.g., 0.2-200 mm and 1-50 mm).

Another aspect of this invention relates to a method of separating oil particles from water using the above-described ceramic membrane. This method includes the steps of (1) flowing a mixture of water and oil particles through the ceramic membrane and (2) allowing the oil particles to adhere onto the carbon nanotubes of the membrane, thereby separating the oil particles from the water.

A further aspect of this invention relates to a method of preparing a ceramic membrane. This preparation method includes the steps of (1) providing a ceramic substrate having pore channels, (2) coating surfaces of the ceramic substrate with a catalyst that facilitates formation of carbon nanotubes, and (3) growing carbon nanotubes on the surfaces of the ceramic substrate aided by the catalyst until the weight of the carbon nanotubes reaches 0.01 to 20% by weight of the ceramic membrane. The ceramic substrate includes pore channels having a diameter of 0.001 to 20 μm. It has a thickness and a porosity the same as those described above, 0.1 to 50 mm and 5 to 95%, respectively.

The details of one or more embodiments of the invention are set forth in the description below. Other features, objects, and advantages of the invention will be apparent from the description and the claims.

### DETAILED DESCRIPTION

The ceramic membrane disclosed herein is useful for removing small oil particles from an oil-in-water emulsion via both the size exclusion filtration mechanism and the affinity adsorption mechanism. It can be used in many fields, e.g., the petroleum-chemical industry, metal-fabrication industry, painting industry, marine industry, and food industry.

Note that the ceramic membrane of this invention can be of various shapes, such as a flat sheet, a plate, a hollow cylinder, and a tube. As pointed out above, this membrane contains a ceramic substrate and carbon nanotubes.

The ceramic substrate can be made of any suitable ceramic materials, including crystalline or partly crystalline solids and amorphous solids (e.g., glasses). Examples include, but are not limited to, boron carbide, boron nitride, spinel, garnet, lanthanum fluoride, calcium fluoride, silicon carbide, carbon and its allotropes, silicon oxide, glass, quartz, silicon nitride, alumina, aluminum nitride, aluminum hydroxide, hafnium boride, thorium oxide, cordierite, mullite, ferrite, sapphire, steatite, titanium carbide, titanium nitride, titanium boride, zinc oxide, zirconia, zirconium carbide, zirconium boride, zirconium nitride, and a combination thereof.

Further, the ceramic substrate can contain one or more additives that modify its properties such as porosity, stability, and hardness. When zirconia is used to prepare the ceramic substrate, it can be blended with one or more additives (i.e., dopants) to stabilize its structure. Common additives include, but are not limited to, magnesium oxide, yttrium oxide, calcium oxide, cerium (III) oxide, and a combination thereof. An yttria-stabilized zirconia (YSZ) is ceramic containing zirconium oxide stabilized by yttrium oxide.

Moreover, the ceramic substrate contains pore channels or throats, i.e., interconnected pores enclosed in ceramic surfaces. The pore channels, within the ceramic substrate, are open voids or spaces that allow a fluid to pass through. For preparation of a ceramic substrate and formation of pore channels in it, see Chen et al., Journal of the American Ceramic Society, 94, 382-390 (2011).

Being porous, the ceramic substrate has a large surface area of 0.01 to 300 m²/g (e.g., 1-100 m²/g and 1-10 m²/g). Surfaces of the ceramic substrate include surfaces enclosing the pore channels and external surfaces.

Turning to the carbon nanotubes, they are crystalline structures having one or more closed concentric, locally cylindrical, graphene layers. Their structure and properties are described in Tasis et al., Chemical Reviews, 106, 1105-36 (2006) and Balasubramanian et al., Small, 1, 180-92 (2005). The carbon nanotubes, either single-walled or multi-walled, can form one or more carbon nanotube networks. Carbon nanotubes are one of the stiffest materials due to their strong sp²-hybridized carbon tubular networks. Their specific tensile strength and Young's modulus are 10-20 times and 5 times of that of stainless steel respectively. See Thostenson et al., Composites Science and Technology, 61, 1899-1912 (2001). Highly hydrophobic carbon nanotubes are ideal binding anchors for oil particles and can be used to remove small oil particles from water. Although carbon nanotubes have been applied in many areas such as connectors in integrated circuits, field emitters, sensors, drug deliveries, and thermal management surfaces, they have not been used in water purification processes.

Carbon nanotubes can be replaced by other carbon allotropes, such as diamond, graphite (e.g., graphene), amorphous carbon (e.g., coal), fullerenes (e.g., carbon nanobuds), glassy carbon, carbon nanofoam, lonsdaleite, and linear acetylenic carbon. See Hugh O. Pierson, Handbook of Carbon, Graphite, Diamond, and Fullerenes: Properties, Processing, and Applications (Noyes Publications, 1993).

Also within the scope of this invention is a method of using the above-described ceramic membrane to separate from water oil particles as small as 1 nm-0.5 mm (e.g., 1 nm-0.1 mm and 1 nm-0.05 mm). Particles larger than 0.01 mm can also be separated by size exclusion. This membrane has an oil rejection rate of 95 to 100% (e.g., 98 to 100% and 99 to 100%) and a permeation flux of 0.01 to 50 L·m⁻²·min⁻¹·atm⁻¹ (e.g., 0.05 to 25 L·m⁻²·min⁻¹·atm⁻¹ and 0.1 to 10 L·m⁻²·min⁻¹·atm⁻¹).

Without being bound by any theory, discussed below is a mechanism of oil separation by carbon nanotube. Carbon nanotubes in the ceramic membrane of this invention, due to their oleophilicity, initially capture small oil particles. The captured oil particles form a thin soft layer on the carbon nanotubes, which becomes an adsorption bed to absorb more oil particles, thereby only allowing water to pass through the ceramic membrane.

Still within the scope of this invention is a method of preparing a ceramic membrane, which includes growing carbon nanotubes on surfaces of a ceramic substrate.

Carbon nanotubes can be grown on surfaces of a ceramic substrate by several known methods such as arc discharge, laser ablation, high-pressure carbon monoxide, and chemical vapor deposition (CVD). See, e.g., Tasis et al. (2006); and Balasubramanian et al. (2005).

Take CVD for example, it involves a catalytic reaction of a carbon-containing gas (e.g., methane, ethylene, ethyne, and ethanol) with a catalyst (i.e., a metal) on surfaces of a substrate.

Before growing carbon nanotubes by CVD, selected surfaces of the ceramic substrate are coated with a layer of a catalyst, which can be a transition metal (e.g., nickel, copper, and iron) in nanoparticle form. The coating can be achieved by ultra-sonicating a substrate in a solution containing metal ions, soaking a substrate in a solution containing metal ions, spin coating a substrate with a solution containing metal ions, or dip-coating a substrate with a solution containing metals ions. Metal catalyst nanoparticles can also be formed on surfaces by reducing coatings of metal oxide or salt (e.g., nickel nitrate). The final catalyst nanoparticles, 0.001-12% by weight of the ceramic substrate, have a particle size of 1 nm to 500 nm (e.g., 1 to 200 nm and 1 to 100 nm).

Growth of carbon nanotubes on a catalyst-coated substrate is achieved as follows. Initially, the substrate is exposed to two gases, i.e., a carbon-containing gas (e.g., acetylene, ethylene, ethanol, and methane) and a process gas (e.g., ammonia, nitrogen, and hydrogen). As an example, a carbon containing gas is allowed to pass through the ceramic substrate at a temperature of 300 to 900° C. (e.g., 350 to 800° C. and 400 to 750° C.) with a flow rate of 5 to 200 L/hour (e.g., 5 to 100 L/hour and 10 to 50 L/hour) for 10 minutes to 4 hours (e.g., 15 minutes to 2 hours and 15 minutes to 1 hour); and, subsequently, a process gas is allowed to pass through the ceramic substrate at a temperature of 300 to 900° C. (e.g., 350 to 800° C. and 400 to 750° C.) with a flow rate of 5 to 200 L/hour (e.g., 5 to 100 L/hour and 10 to 50 L/hour) for 10 minutes to 4 hours (e.g., 15 minutes to 2 hours and 15 minutes to 1 hour). The carbon-containing gas is cracked on surfaces of metal catalyst nanoparticles and forms carbon nanotubes. The catalyst nanoparticles may stay at the tips of the carbon nanotubes or remain at the bases. Typically, the weight of the carbon nanotubes is kept at 0.01 to 40% (e.g., 0.1-20% and 0.5-5%) by weight of the ceramic membrane.

The ceramic membrane of this invention possesses two unexpected advantages. Namely, it achieves a 100% rejection for oil particles as small as 1 nm and has a high flux of 0.8 L·m⁻²·min⁻¹·atm⁻¹. Further, the membrane is easy to make at a large scale and is also easy to use in various industries. Moreover, oil filtration using this membrane is more cost effective than current techniques, such as biological treatment and activated carbon adsorption.

The specific examples below are to be construed as merely illustrative, and not limitative of the remainder of the disclosure in any way whatsoever. Without further elaboration, it is believed that one skilled in the art can, based on the description herein, utilize the present invention to its fullest extent. All publications cited herein are incorporated by reference in their entirety.

### EXAMPLE 1

Three ceramic membranes were prepared following the below-described procedures.

### Embedding Catalyst Nanoparticles in a Ceramic Substrate

A ceramic substrate was fabricated using an in-situ pore-forming technique disclosed in Chen et al (2011). Yttria-stabilized zirconia (YSZ) was used to prepare a ceramic substrate, which was a cylinder (diameter, 2.6 cm; thickness, 0.19 cm) containing pore channels, i.e., throat-like pores.

This porous YSZ ceramic substrate had a total pore area of 21.844 m² and a porosity of 36%, measured by a mercury porosimetery method. The diameter of the pore channels was between 0.001 to 10 μm, also by a mercury porosimetery method. The majority of the pores were between 0.7 μm and 1 μm.

In the next step, a nickel catalyst was introduced onto surfaces of the ceramic substrate by sonicating the porous ceramic substrate for 15 minutes in a nickel nitrate ethanol solution, having a concentration of 0.1 g/mL to 0.5 g/mL. Nickel nitrate particles thus resided on surfaces of the ceramic substrate. After sonication, the ceramic substrate was placed in an oven at 80° C. for 15 minutes to remove residual ethanol, leaving behind nickel nitrate nanoparticles on the surfaces. This step was repeated thrice to ensure all the surfaces were covered with nickel nitrate particles.

### Growing Carbon Nanotubes by Chemical Vapor Deposition

The nickel-nitrate-coated ceramic substrate was placed in a tubular furnace, in which different gases passed through at various temperatures. First, a hydrogen gas was applied to reduce nickel nitrate to nickel. It passed through the furnace at 16 L/hour for 5 minutes at room temperature, and then for 1 hour at 400° C. At the end of this step, the nickel nitrate was reduced to the metal nickel. Second, carbon nanotubes grew on surfaces of the ceramic substrate. The furnace temperature was raised to a temperature between 400-800° C. A methane gas instead of the hydrogen gas was allowed to pass through the furnace at 8 L/hour for 1 hour. Subsequently, the hydrogen gas again passed through the furnace at 16 L/h for 1 hour at 750° C. The ceramic membrane thus obtained was cooled to room temperature in the hydrogen environment in the furnace.

Three ceramic membranes were made following the procedures described above. To facilitate discussion, the membranes were named as YSZ (a, b), in which a was carbon nanotubes growing temperature and b was the concentration of the nickel nitrate ethanol solution. As such, the three ceramic membranes were YSZ (425° C., 0.2 g/mL), YSZ (425° C., 0.3 g/mL), and YSZ (750° C., 0.2 g/mL).

### EXAMPLE 2

The three ceramic membranes prepared in Example 1 were characterized by a field-emission scanning electron microscope (FESEM) and a transmission electron microscope (TEM).

These ceramic membranes were photographed and measured by FESEM. FESEM micrographs showed that the nickel particles of 10-50 nm were evenly distributed on surfaces of the ceramic substrate after the reducing step. The fact that these nanoparticles were observed under vacuum indicated that intermolecular forces between the nickel nanoparticles and the ceramic material are sufficient for the growth of carbon nanotubes. Otherwise, the carbon nanotubes would not be able to adhere to the surfaces.

Further, the FESEM micrographs of carbon nanotubes showed that the temperature of the furnace had a great impact on carbon nanotubes growth. Generally, a temperature was kept between 300 and 800° C., preferably between 350 and 750° C., more preferably between 400 and 750° C., and most preferably between 400 and 425° C., and between 725 and 750° C.

Moreover, FESEM micrographs demonstrated that carbon nanotubes thus formed were disordered and entangled without preferential alignment. These carbon nanotubes formed a sponge-like network that greatly increased the surface area of the ceramic membrane. It was found by nitrogen adsorption analyses that the surface area was 2.373 m²/g for carbon nanotubes obtained at 750° C. and was 4.188 m²/g for carbon nanotubes obtained at 425° C., both using 0.3 g/mL Ni(NO₃)₂ ethanol solution. These large surface areas provided sufficient binding sites to capture oil particles in water.

Other than photographed by a FESEM, the prepared ceramic membranes were also observed under a TEM. TEM micrographs revealed that nickel nanoparticles were near the top end of the carbon nanotubes, which were multi-walled with parallel well-graphitized walls.

### EXAMPLE 3

The three membranes prepared in Example 1 were tested for separating oil from water. Their permeation fluxes and rejections were calculated.

In these tests, an oil-in-water emulsion was prepared as follows: 150 ul of blue ink (69% of mineral oil, Metal Ink, Lion, Japan) and 0.8 g of sodium dodecyl sulfate (SDS, Fluka, Switzerland) were added to 500 ml of water. Oil concentrations were determined by a UV spectroscope (UV-3600, Shimadzu, Singapore); particle sizes were measured by dynamic light scattering (90 Plus, Brookhaven Instruments Corporation, US) and observed under microscope; and dissolved oil concentrations were obtained by an oil content analyzer (OCMA-300, Horiba, Singapore).

The ceramic membranes were tested at 25° C. in a cross-flow membrane test unit, which contained a gear pump, a relief valve, and a pressure gauge. The effective membrane area for permeation measurements was 3.142 cm². The trans-membrane pressure was kept at 14 psi.

Two key performance indexes of the ceramic membranes, i.e., permeation flux (PF) and rejection, were calculated based on data collected from the tests. PF represents the amount of permeate or the product rate and is defined as the volume of permeate (V) per unit membrane area (A) per unit time (t):

$$PF = ( \frac{V}{At} ) .$$

Rejection (R) is calculated as follows:

$$R ( \% ) = ( 1 - \frac{{C}_{p}}{{C}_{f}} ) \times 100 ,$$

where Cₚ is the oil concentration in filtered water and C_{f} is oil concentration before filtration.

Among the ceramic membranes, YSZ (750° C., 0.2 g/mL) had a permeation flux of 0.8 L·m⁻²·min⁻¹·atm⁻¹ and a rejection of 100%, YSZ (425° C., 0.2 g/mL) had a permeation flux of 0.05 L·m⁻²·min⁻¹·atm⁻¹ and a rejection greater than 90%, and YSZ (425° C., 0.3 g/mL) had a permeation flux of 0.05 L·m⁻²·min⁻¹·atm⁻¹ and a rejection rate greater than 95%. By contrast, a porous ceramic membrane without carbon nanotubes had a rejection rate lower than 88%.

Furthermore, YSZ (750° C., 0.2 g/mL) maintained its rejection of 100% over a three-day continuous filtration. Its permeation flux was still over 0.2 L·m⁻²·min⁻¹·atm⁻¹ at the end of the third day.

Finally, carbon nanotubes were not washed off from the ceramic membranes as the permeated water samples did not show a single carbon nanotube by TEM.

### OTHER EMBODIMENTS

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar, features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the claims.

What is claimed is:

1. A ceramic membrane for separating oil from water, the membrane comprising:
a ceramic substrate having pore channels, and
carbon nanotubes extending from surfaces of the ceramic substrate,
wherein the ceramic substrate has a thickness of 0.1 to 50 mm and a porosity of 5 to 95%, the pore channels have a diameter of 0.001 to 20 μm, and the carbon nanotubes constitute 0.01 to 40% by weight.

2. The ceramic membrane of claim 1, wherein the ceramic substrate is zirconia, alumina, silicon carbide, silicon nitride, titanium carbide, zinc oxide, boron nitride, mullite, or a combination thereof.

3. The ceramic membrane of claim 2, wherein the ceramic substrate is zirconia.

4. The ceramic membrane of claim 3, wherein the ceramic substrate has a thickness of 0.2 to 20 mm and a porosity of 10 to 70%, the pore channels have a diameter of 0.005 to 10 μm, and the carbon nanotubes constitute 0.1 to 20% by weight.

5. The ceramic membrane of claim 4, wherein the ceramic substrate has a thickness of 0.5 to 5 mm and a porosity of 20 to 50%, the pore channels have a diameter of 0.01 to 2 μm, and the carbon nanotubes constitute 0.5 to 5% by weight.

6. The ceramic membrane of claim 2, wherein the ceramic substrate has a thickness of 0.2 to 20 mm and a porosity of 10 to 70%, the pore channels have a diameter of 0.005 to 10 μm, and the carbon nanotubes constitute 0.1 to 20% by weight.

7. The ceramic membrane of claim 6, wherein the ceramic substrate has a thickness of 0.5 to 5 mm and a porosity of 20 to 50%, the pore channels have a diameter of 0.01 to 2 μm, and the carbon nanotubes constitute 0.5 to 5% by weight.

8. The ceramic membrane of claim 1, wherein the ceramic substrate has a thickness of 0.2 to 20 mm and a porosity of 10 to 70%, the pore channels have a diameter of 0.005 to 10 μm, and the carbon nanotubes constitute 0.1 to 20% by weight.

9. The ceramic membrane of claim 8, wherein the ceramic substrate has a thickness of 0.5 to 5 mm and a porosity of 20 to 50%, the pore channels have a diameter of 0.01 to 2 μm, and the carbon nanotubes constitute 0.5 to 5% by weight.

10. The ceramic membrane of claim 1, wherein the ceramic membrane is a cylinder having an outside diameter of 0.05 to 1000 mm.

11. The ceramic membrane of claim 10, wherein the ceramic substrate has a thickness of 0.2 to 20 mm and a porosity of 10 to 70%, the pore channels have a diameter of 0.005 to 10 μm, and the carbon nanotubes constitute 0.1 to 20% by weight.

12. The ceramic membrane of claim 10, wherein the ceramic substrate has a thickness of 0.5 to 5 mm and a porosity of 20 to 50%, the pore channels have a diameter of 0.01 to 2 μm, and the carbon nanotubes constitute 0.5 to 5% by weight.

13. The ceramic membrane of claim 10, wherein the ceramic membrane is a cylinder having an outside diameter of 0.2 to 200 mm.

14. The ceramic membrane of claim 13, wherein the ceramic substrate has a thickness of 0.2 to 20 mm and a porosity of 10 to 70%, the pore channels have a diameter of 0.005 to 10 μm, and the carbon nanotubes constitute 0.1 to 20% by weight.

15. The ceramic membrane of claim 14, wherein the ceramic substrate has a thickness of 0.5 to 5 mm and a porosity of 20 to 50%, the pore channels have a diameter of 0.01 to 2 μm, and the carbon nanotubes constitute 0.5 to 5% by weight.

16. The ceramic membrane of claim 13, wherein the ceramic membrane is a cylinder having an outside diameter of 1 to 50 mm.

17. The ceramic membrane of claim 16, wherein the ceramic substrate has a thickness of 0.2 to 20 mm and a porosity of 10 to 70%, the pore channels have a diameter of 0.005 to 10 μm, and the carbon nanotubes constitute 0.1 to 20% by weight.

18. The ceramic membrane of claim 17, wherein the ceramic substrate has a thickness of 0.5 to 5 mm and a porosity of 20 to 50%, the pore channels have a diameter of 0.01 to 2 μm, and the carbon nanotubes constitute 0.5 to 5% by weight.

19. A method of separating oil particles from water, the method comprising:
flowing a mixture of water and oil particles through a ceramic membrane of claim 1, and
allowing the oil particles to adhere onto the carbon nanotubes,
whereby separating the oil particles from the water.

20. A method of preparing a ceramic membrane, the method comprising:
providing a ceramic substrate having pore channels,
coating surfaces of the ceramic substrate with a catalyst that facilitates formation of carbon nanotubes, and
growing carbon nanotubes on the surfaces of the ceramic substrate aided by the catalyst until the weight of the carbon nanotubes reaches 0.01 to 40% by weight, wherein the ceramic substrate has a thickness of 0.01 to 50 mm and a porosity of 5 to 95%, and the pore channels have a diameter of 0.001 to 20 μm.
